(19) United States
(12) Patent Application Publication
(10) Pub. No.: US 2026/0350710 A1
(43) Pub. Date: Nov. 5, 2026

(54) COMPUTER SYSTEM AND METHOD FOR TRAINING AND UTILIZING A MACHINE LEARNING MODEL FOR DETERMINING PERSONALIZED COSTS ASSOCIATED WITH LONG-TERM CARE

(71) Applicant: The Prudential Insurance Company of America, Newark, NJ (US)

(72) Inventors: Wei Zhao, Jersey City, NJ (US); Yamei Tu, Newark, NJ (US)

(73) Assignee: The Prudential Insurance Company of America, Newark, NJ (US)

(21) Appl. No.: 19/196,245

(22) Filed: May 1, 2025

(51) Int. Cl. G06Q 40/08; G06N 3/09

(52) U.S. Cl. CPC G06Q 40/08; G06N 3/09

(57) ABSTRACT

A computer system and method/process for training a machine learning (ML) model for determining personalized costs associated with long-term care (LTC), expressed as predictive distribution. One or more external and internal datasets are accessed having data related to LTC, which are then subject to cleansing such that each accessed dataset is suitable for being aggregated in a training dataset for training one or more ML models relating to LTC predictions. A training dataset is then complied by aggregating each of the accessed datasets, wherein the training dataset is operative to train one or more ML models associated with predicting costs relating to LTC. An LTC cost ML model is then trained utilizing the training dataset, which LTC cost ML model includes one or more ML model modules each being configured and operative to utilize one or more artificial intelligence (AI) techniques for predicting LTC costs predicted upon certain input data related to a request for such predictions.

### BACKGROUND

### 1. Field

Artificial Intelligence (AI) based system, apparatus and processes for performing predictive analytics and machine learning-based systems for generating personalized long-term care expense projections, and more particularly to computational methodologies for processing and harmonizing multiple health-related data sources and training machine learning (ML) models to generate actionable data suitable for use in financial planning.

### 2. Description of Related Art

Long-term care (LTC) expenses represent increasingly significant financial challenges for individuals, families, and financial institutions in contemporary society. The complexity and magnitude of such expenses create substantial difficulties in financial planning and risk management processes. Existing methodologies for expense prediction and financial planning often fail to provide accurate, actionable insights due to various technological limitations described herein. The absence of reliable predictive tools has resulted in widespread financial planning inefficiencies, whereby individuals and institutions frequently underestimate, or overestimate required LTC financial reserves. Such miscalculations can result in substantial adverse financial consequences for stakeholders across the LTC ecosystem.

Traditional approaches to LTC cost estimation have primarily relied upon actuarial models and rule-based systems. While actuarial models provide robust analytical capabilities, such models are inherently limited by their reliance on historical data and inability to integrate dynamic factors including, but not limited to, emerging health trends, personalized patient data, evolving LTC costs, and regional economic variations. Similarly, rule-based systems exhibit limited adaptability to new data and often produce oversimplified predictions that fail to account for the complex interplay of individual health trajectories and demographic factors.

Recent implementations of machine learning technologies in the LTC technology field have introduced new predictive capabilities. However, such implementations are characterized by significant limitations, including: (a) insufficient data depth due to reliance on single data sources, whereby the resultant predictions fail to capture the full complexity of LTC cost trajectories; (b) lack of interpretability of predictive outputs, whereby the “black box” nature of such systems causes limited trust and adoption among stakeholders; and (c) fragmented analytical approaches that fail to provide integrated cost projections, resulting in isolated insights that do not adequately address the interconnected nature of LTC expenses.

Insurance providers face particular challenges in implementing existing solutions, whereby the absence of granular predictive capabilities impedes accurate premium calculations and risk assessment processes. Traditional methodologies fail to adequately account for individual variation in health status, lifestyle factors, and regional cost differences, resulting in suboptimal pricing strategies and potential risk exposure.

Furthermore, current systems exhibit significant limitations in their ability to adapt to evolving health landscapes, whereby rapid changes in medical technology, treatment protocols, and care delivery models necessitate increased sophisticated predictive capabilities than those provided by existing solutions. The limitations of current technologies create a significant need for more advanced, integrated approaches to LTC cost prediction and financial planning.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. It is to be understood and appreciated the illustrated embodiments described herein provides a solution to the long-standing problem of LTC cost computer prediction by implementing advanced computational methodologies in conjunction with comprehensive data integration. In one illustrated embodiment, the described system and process is implemented through a web-based application interface, enabling partner access while maintaining capability for application programming interface (API) integration.

It is to be further understood and appreciated the illustrated embodiments described herein relate to predictive analytic computer systems in LTC cost estimation, and more particularly to machine learning-based computer systems for generating personalized LTC expense projections. Specifically, the illustrated embodiments include computational methodologies for processing and harmonizing multiple health-related data sources and training machine learning models to generate electronic data useful for actionable financial planning insights. The illustrated embodiments include specialized computer protocols for data harmonization, whereby, for instance, disparate health-related electronic datasets undergo systematic integration to enable comprehensive cost predictions. Further, the illustrated embodiments relate to cloud-based deployment computer architectures for LTC analytics, specifically implementing distributed computing methodologies for ML model training and inference. The illustrated embodiments include scalable infrastructure components enabling real-time generation of personalized LTC cost predictions preferably through standardized application programming interfaces.

It is to be further appreciated and understood the illustrated embodiments encompasses multiple domains including, but not limited to a) LTC analytics and predictive modeling; b) machine learning system implementation; c) data harmonization and integration; d) cloud computing architecture; and e) financial planning computing technology.

The illustrated embodiments described herein addresses, and overcomes, prior art limitations by providing a comprehensive predictive ML computer platform for LTC cost estimation. For instance, the computer system and process of the illustrated embodiments generate personalized financial planning insights through integration of multiple electronic data sources. The computer system and process of the illustrated embodiments described herein enables users to (a) generate accurate predictions for LTC costs; (b) obtain explainable and actionable insights; and (c) customize projections for various scenarios, using advanced ML modeling and AI techniques.

To achieve these and other advantages and in accordance with the purpose of the illustrated embodiments, in one aspect, described is a computer system and method/process for training a ML model for determining personalized costs associated with LTC. Accessed is one or more external datasets including data related to LTC, and one or more internal datasets including proprietary data related to LTC, which are then subject to cleansing such that each accessed dataset is suitable for being aggregated in a training dataset for training one or more ML models relating to LTC predictions. A training dataset is then complied by aggregating each of the accessed datasets, wherein the training dataset is operative to train one or more ML models associated with predicting costs relating to LTC. An LTC cost ML model is then trained utilizing the training dataset, which LTC cost ML model includes one or more ML models each being configured and operative to utilize one or more AI techniques for predicting LTC costs predicted upon certain input data related to a request for such predictions.

In accordance with another aspect, described is a computer system and method/process for utilizing a trained ML model for determining LTC costs. Input data is received relating to a user request for predicted LTC costs, which is then preferably preprocessed into a format suitable for utilization by one or more trained ML models. The preprocessed user input data is applied to the trained one or more LTC cost ML models each being configured and operative to utilize one or more AI techniques for predicting LTC costs predicated upon the preprocessed user input data. Output data is generated from the one or more trained LTC cost ML models containing predicted LTC costs responsive to the user input data.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an AI device utilized with one or more of the illustrated embodiments;

FIG. 4 illustrates a diagram depicting an AI server utilized with one or more of the illustrated embodiments;

FIG. 5 is a system level diagram depicting a computer system utilized with one or more of the illustrated embodiments associated with costs associated with LTC; and

FIGS. 6 and 7 are flowcharts depicting methods of operation in accordance with one or more of the illustrated embodiments depicted in FIG. 5.

### DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this illustrated embodiment belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

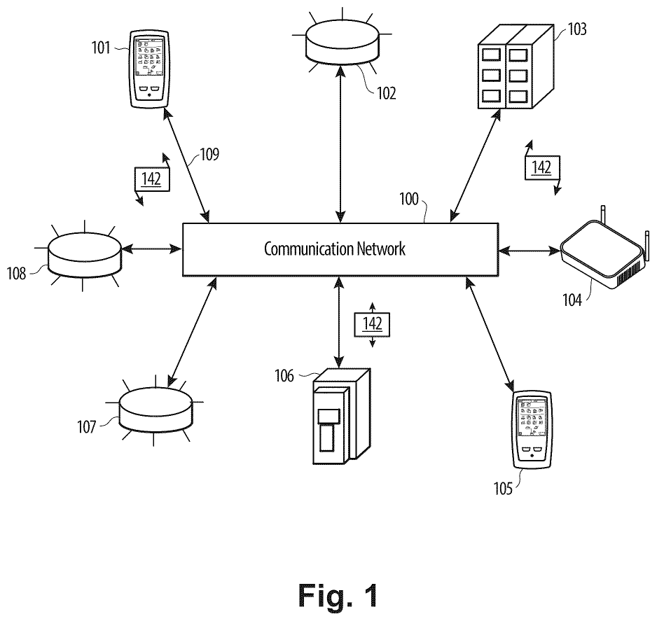

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively including nodes/devices 101-108 (e.g., Personal Digital Assistant Devices (PDAs) 101, sensors 102, computing devices 103, smart phone devices 105, web servers/computer systems 106, computer systems 107, switches 108, internal and external databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the illustrated embodiments may be written in any combination of one or more programming languages, including an object oriented programming language such as Python, Golang, Ruby, ASP.NET, Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a computer (e.g., web servers/computer systems 106), or other programmable data processing apparatus to produce a machine, such that the instructions, which execute via the processor of the computer or other programmable data processing apparatus, create means for implementing the functions/acts specified in the flowchart and/or block diagram block or blocks, such as training, and utilizing, an ML model for determining personalized costs associated with LTC.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

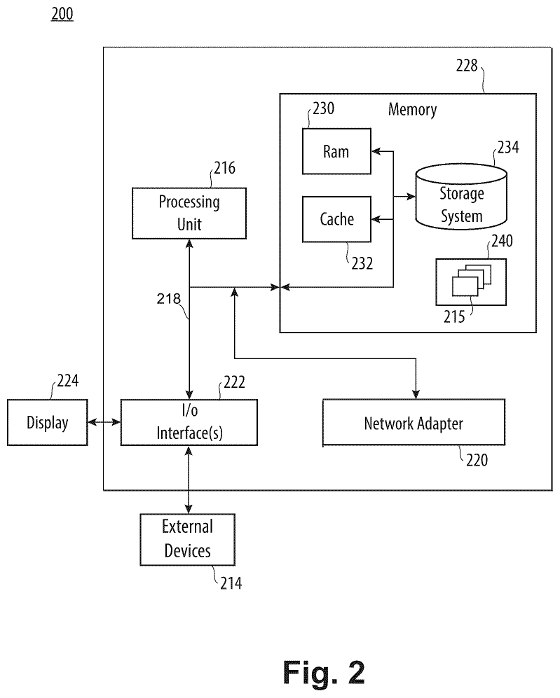

FIG. 2 is a schematic block diagram of an example network computing device 200 (e.g., client computing device 103, web server/computer system 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, including training, and utilizing, an ML model for determining personalized costs associated with LTC.

Computing device 200 is operational with numerous other computing system environments or configurations. Examples of well-known computing systems, environments, and/or configurations that may be suitable for use with computing device 200 include, but are not limited to, cloud computing systems (including, but not limited to: Infrastructure as a Service (IaaS); Software as a Service (SaaS); Platform as a Service (PaaS); and Private cloud), personal computer systems, server computer systems, thin clients, thick clients, hand-held or laptop devices, multiprocessor systems, microprocessor-based systems, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices. In accordance with the illustrated embodiments, computing device 200 is configured and operative to training, and utilize, an ML model for determining personalized costs associated with LTC.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein, including, but not limited to training, and utilizing, an ML model for determining personalized costs associated with LTC.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: big data technologies encompassing large and diverse datasets that are significant in volume, which are commonly used in machine learning, predictive modeling, and other advanced analytics to solve business problems and make informed decisions; non-relational databases (NoSQLs); Blob storage; relational databases (SQL); as well as microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/AI to train, and utilize, an ML model for determining personalized costs associated with LTC amongst other determinations and functionalities, as described herein. Thus, preferably integrated into an ML computer system (e.g., 106) coupled to a plurality of external databases/data sources is an AI system (e.g., an Expert System) that implements ML and AI algorithms to conduct one or more of the above-mentioned related predictions of certain LTC cost tasks, preferably on an automated basis. For instance, the AI system may include two subsystems: a first sub-system that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

In accordance with the illustrated embodiments described herein, AI refers to the field of studying AI or methodology for making AI, and ML refers to the field of defining various issues dealt with in the field of AI and studying methodology for solving the various issues. ML is defined as an algorithm that enhances the performance of a certain task through a steady experience with the certain task.

Also, in accordance with the illustrated embodiments, an artificial neural network (ANN) is a model used in ML and may mean a whole model of problem-solving ability which is composed of artificial neurons (nodes) that form a network by synaptic connections. The ANN can be defined by a connection pattern between neurons in different layers, a learning process for updating model parameters, and an activation function for generating an output value. The ANN may include an input layer, an output layer, and optionally one or more hidden layers. Each layer includes one or more neurons, and the ANN may include a synapse that links neurons to neurons. In the ANN, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the ML algorithm before learning, and includes a learning rate, a repetition number, a mini batch size, and an initialization function. The purpose of the learning of the ANN may be to determine the model parameters that minimize a loss function. The loss function may be used as an index to determine optimal model parameters in the learning process of the ANN. ML may be classified into supervised learning, unsupervised learning, and reinforcement learning according to a learning method. The supervised learning may refer to a method of learning an ANN in a state in which a label for learning data is given, and the label may mean the correct answer (or result value) that the ANN must infer when the learning data is input to the ANN. The unsupervised learning may refer to a method of learning an ANN in a state in which a label for learning data is not given. The reinforcement learning may refer to a learning method in which an agent defined in a certain environment learns to select a behavior or a behavior sequence that maximizes cumulative compensation in each state.

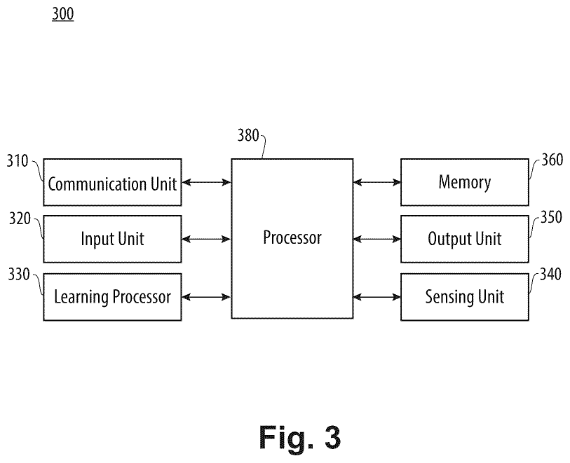

ML, which is preferably implemented as a deep neural network (DNN) including a plurality of hidden layers among ANN, is also referred to as deep learning, and the deep learning is part of ML. FIG. 3 illustrates an AI device 300 according to an illustrated embodiment. In accordance with the illustrated embodiments, the AI device 300 is preferably integrated into a computer system 103 and method/process for training an ML model for determining personalized costs associated with LTC.

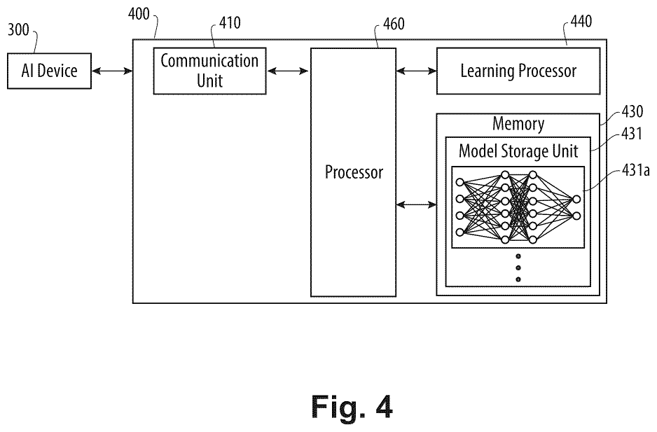

Referring now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 360, and a processor 380. The communication unit 310 may transmit and receive data to and from external devices such as other AI devices 300a to 300e and an AI server 400 (FIG. 4) by using wire/wireless communication technology. For example, the communication unit 310 may transmit and receive sensor information, a user input, a learning model, and a control signal to and from external devices.

The communication technology used by the communication unit 310 may preferably include GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited to health-related data and data relating to LTC costs, preferably from both internal databases (e.g., containing proprietary data relating to clients) and external databases (e.g., public record databases relating to health conditions). The input unit 320 may acquire a learning data for model learning and an input data to be used when an output is acquired by using learning model. The input unit 320 may acquire raw input data. In this case, the processor 380 or the learning processor 330 may extract an input feature by preprocessing the input data. The learning processor 330 may learn a model composed of an ANN by using learning data. The learned ANN may be referred to as a learning model. The learning model may be used to an infer result value for new input data rather than learning data, and the inferred value may be used as a basis for determination to perform a certain operation.

At this time, the learning processor 330 may perform AI processing together with the learning processor 330 of the AI server 400, and the learning processor 330 may include a memory integrated or implemented in the AI device 300. Alternatively, the learning processor 330 may be implemented by using the memory 360, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 360 preferably stores data that supports various functions of the AI device 300. For example, the memory 360 may store input data acquired by the input unit 320, learning data, a learning model, a learning history, and the like.

The processor 380 preferably determines at least one executable operation of the AI device 300 based on information determined or generated by using a data analysis algorithm or a ML algorithm. The processor 380 may control the components of the AI device 300 to execute the determined operation. To this end, the processor 380 may request, search, receive, or utilize data of the learning processor 330 or the memory 360. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. The processor 380 may further acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an ANN, at least part of which is learned according to the ML algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI device 300 so as to drive an application program stored in memory 360. Furthermore, the processor 380 may operate two or more of the components included in the AI device 300 in combination so as to drive the application program.

FIG. 4 illustrates an AI server 400 according to the illustrated embodiments. It is to be appreciated that the AI server 400 may refer to a device that learns an ANN by using an ML algorithm or uses a learned ANN. The AI server 400 may include a plurality of servers to perform distributed processing or may be defined as a 5G network. At this time, the AI server 400 may be included as a partial configuration of the AI device 300 and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an ANN 431a) through the learning processor 440.

The learning processor 440 may learn the ANN 431a by using the learning data. The learning model may be used in a state of being mounted on the AI server 400 of the ANN or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

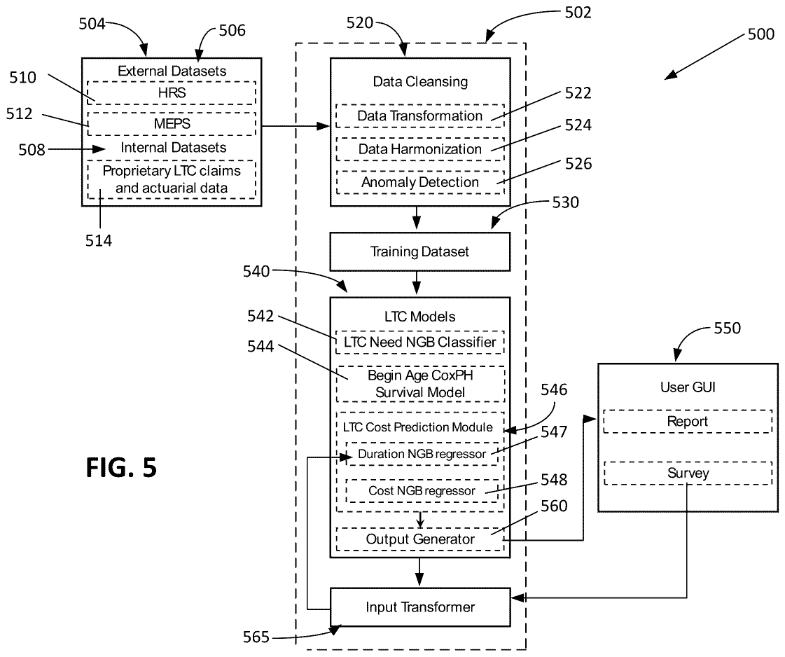

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided with below reference to FIG. 5. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood and appreciated, that in accordance with one aspect of the illustrated embodiments, multiple data sources (e.g., 504) are utilized and processed through specialized methodologies, as described herein. For instance, health-related data may be derived from publicly available data sources, such as the Health and Retirement Study (HRS) (510) and the Medical Expenditure Panel Survey (MEPS) 512), and LTC expenditure data may be derived from the internal proprietary datasets (508). The below computer system 106 of the illustrated embodiments (e.g., 502 of FIG. 5) preferably implements certain selection criteria whereby data is filtered to include records from a certain prescribed time period (e.g., 2010 to 2022), preferably focusing on individuals of all ages. As described herein, the illustrated embodiments described herein preferably utilize a computer system 502 that includes one or more components of the: a) computer system 200 (FIG. 2, (e.g., computer device 106 of FIG. 1)); b) AI computer device 300 (FIG. 3); and c) AI computer server 400 (FIG. 4).

The LTC cost analysis protocol, as further described below, of the illustrated embodiments preferably encompasses multiple expense categories, including, but not limited to, in-home care, assisted living facility, and nursing home as defined herein. For instance, in operation, the computer system 502 implements a three-stage data processing protocol whereby: (a) health conditions variables are systematically identified; (b) observations are retained based on a validity threshold (e.g., 50%) for key variables; and (c) projected costs incorporate an annual inflation adjustment (e.g., 3%) of the rate being preferably derived from (but not limited to) the internal datasets (e.g., 508).

With regard to LTC onset prediction, and in accordance with another aspect of the illustrated embodiments, the computer system 502 may preferably utilize longitudinal data from the HRS (510) and MEPS (512) datasets, whereby temporal changes in individual health status and care requirements are captured. It is to be appreciated that longitudinal data refers to data that is collected from the same subjects repeatedly over a period of time, which is particularly useful for studying changes and developments over time, as it enables researchers to observe how variables of interest evolve.

In accordance with the illustrated embodiments, the computer system 502 preferably implements, as described further below, a specialized data processing protocol wherein: (a) time-to-event data is constructed through identification of first recorded instances of: LTC utilization; LTC service implementation; or presence of two or more activities of daily living (ADL) limitations; (b) geographic data, demographic data, health conditions, and lifestyle factors undergo standardization and normalization; and (c) right-censoring is implemented for subjects without recorded LTC service utilization within the observation period.

With regard to LTC need assessment, and in accordance with certain illustrated embodiments, the computer system 502 is further configured and operational to implement a comprehensive assessment protocol utilizing data from both HRS and MEPS datasets (e.g., 510, 512 of FIG. 5) specifically relating to LTC, whereby the HRS data components 510 may include functional limitation variables including, but not limited to, difficulties in: a) bathing; b) dressing; c) eating; d) walking; and e) incontinence management. And the MEPS data components 512 preferably encompasses data from a prescribed time period (e.g., 2017 to 2020) and encompass subjects aged in a prescribed age group (e.g., 0 to 85 years), which preferably includes functional limitation variables including, but not limited to, difficulties in, for instance: a) bending; b) bathing; c) dressing; d) executing errands; and e) finger dexterity. Preferably, the computer system 502 is configured and operative such that each functional limitation undergoes binary variable conversion, whereby presence or absence of difficulty is indicated. The computer system 502 preferably generates a composite variable representative of the quantity of ADLs an individual cannot perform, wherein subjects unable to perform two or more such activities are classified as requiring LTC.

With regard to another aspect of the illustrated embodiments, and again specifically relating to LTC claims data, proprietary data (e.g., insurance claims data) is derived from an entity's LTC insurance claims internal data repository (e.g., 508 of FIG. 8). For instance, such LTC claims data may include: a) claimant geographic and demographic information; b) claim initiation justifications; c) care duration metrics; and d) monetary claim quantities. Preferably, the computer system 106 described herein processes and integrates these multiple data sources to enable comprehensive LTC predictions, as will be further described below.

With regard to another aspect of the illustrated embodiments, specifically relating to data harmonization, the computer system 502 is further configured and operational to preferably implement a data integration protocol whereby data from the HRS and the MEPS datasets (e.g., 510, 512) undergo harmonization. Preferably, the computer system 502 performs a variable standardization protocol whereby semantically equivalent variables from disparate sources are unified through a systematic mapping process. In operation, the computer system 502 identifies and processes analogous variables, such as functional limitations including, but not limited to, bathing and dressing difficulties, which are present in both HRS and MEPS datasets (e.g., 510, 512).

The computer system 502 is further preferably configured and operational to implement a standardization protocol whereby the aforesaid data variables are transformed into a unified format, ensuring consistency across the combined dataset. In accordance with this aspect of the illustrated embodiments, the computer system 502 further preferably implements a validation protocol whereby the harmonized variables undergo verification to maintain data integrity. It is noted, this unified training dataset created (e.g., 530) serves as input for the multiple predictive models (e.g., 540), whereby the enhanced data richness enables significantly increased robustness of predictions than would be possible via prior art systems and methods that were dependent upon single-source data, as will be further described below.

With regard to yet another aspect of the illustrated embodiments, and specifically relating to data storage infrastructure, the computer system 502 is further configured and operative to implement a comprehensive data storage protocol, which may utilize, for instance Amazon Web Services (AWS) Simple Storage Service (S3) (a scalable object storage infrastructure). Preferably, the system 502 is operative and configured to maintain distinct storage buckets for raw data ingestion, processed datasets, and model artifacts, whereby HRS and MEPS data (e.g., 510, 512), and any proprietary datasets (e.g., 514) undergo systematic organization within dedicated storage hierarchies. In operation, the storage protocol preferably implements versioning capabilities, enabling systematic tracking of data transformations and ensuring reproducibility of analytical procedures. The computer system 502 is further configured and operational to implement role-based access control mechanisms, whereby data access is regulated, such as through AWS Identity and Access Management (IAM) policies, ensuring compliance with data security requirements while maintaining operational efficiency.

With regard to another aspect of the illustrated embodiments, specifically relating to training ML models (e.g., 540), the computer system 502 is configured and operative to perform a comprehensive methodology for transforming raw health- and LTC-related data into predictive insights through certain computational methodologies, including one or more AI techniques. The computer system 502 may preferably include multiple predictive models (e.g., 540) each preferably addressing distinct aspects of LTC prediction. In operation, the computer system 502 preferably implements a systematic data partitioning protocol, whereby an input dataset (e.g., 504) undergoes division such that a certain percentage thereof (e.g., 80%) is allocated to a training subset (e.g., 530) for model development purposes, with the remaining percentage thereof (e.g., 20%) being reserved for validation and performance assessment of trained ML models (e.g., 540). It is to be appreciated that such data partitioning ensures robust model development while maintaining sufficient data for accurate performance evaluation.

The computer system 502 is further configured and operative to implement a data preprocessing protocol (e.g., 520), whereby numerical variables undergo median imputation, such that missing values are replaced with the median value within the training set. It is noted a particularly innovative aspect of this embodiment is that it involves the processing of categorical variables, whereby missing values are systematically replaced with zero values, and “Not a Number” (NaN) entries are interpreted as “inapplicable”. With regard to another aspect of the illustrated embodiments, specifically relating to anomaly detection, the computer system 502 is further configured and operative to preferably utilize Cook's distance methodology in conjunction with ordinary least squares regression, whereby the computer system 502 calculates a statistical measure for each data point and systematically eliminates observations exceeding a data-driven threshold thereof. The Cook's distance (D) of a data point i is defined as

$${D}_{i} = \frac{{\sum }_{j = 1}^{n} {( {\hat{y}}_{j} - {\hat{y}}_{j ( i )} )}^{2}}{p M S E} ,$$

where ŷⱼ is the jth fitted response value, \hat{γ}ⱼ₍ᵢ₎ is the jth fitted response value, where the fit does not include data point i, MSE is the mean squared error, and p is the number of coefficients in the regression model.

Further, it is to be understood the computer system 502 of the illustrated embodiments, and with regard to LTC assessment, may include multiple specialized models, wherein, for instance: a) a first NGB regressor is implemented for LTC duration prediction; b) an NGB classifier is utilized for LTC need assessment; and c) a second NGB regressor is employed for LTC expense prediction.

With regard to yet another aspect of the illustrated embodiments and relating to LTC onset prediction, the computer system 502 is preferably configured and operative to utilize a Cox Proportional Hazards (CoxPH) model for LTC onset prediction. Thus, the computer system 502 provides sophisticated handling of censored observations, preferably defined as instances, where the initiation of LTC services remains unobserved within a certain time period (e.g., a study period). The computer system 502 may preferably synthesize multiple indicators to determine the onset of LTC needs. For instance, such indicators may include (and are not limited to): a) residency status in nursing homes or institutional care facilities; b) utilization of home care services; and c) presence of functional limitations, such as, two or more ADL impairments.

It is to be further understood and appreciated that each predictive ML model (e.g., 540) described herein may be optimized through a randomized hyperparameter search protocol, whereby numerous distinct configuration combinations (e.g., 100 combinations) are utilized. This optimization process preferably utilizes specific performance metrics, including mean squared error and adjusted R-squared for regression, balanced accuracy for classification, and concordance index for survival analysis, to refine the predictive capabilities thereof. The computer system 502 described herein may be configured and operative to enable generation of probabilistic predictions across multiple health-related domains. For instance, the computer system 502 is configured and operative to provide: a) a comprehensive approach to handling missing and potentially anomalous data; b) a hybrid methodology combining anomaly detection and regression techniques; c) a process for generating nuanced, probabilistic predictions; and/or d) a systematic approach to model optimization through hyperparameter methodologies.

With regard to yet another aspect of the illustrated embodiments, the computer system's (e.g., 502) development and deployment infrastructure may be implemented utilizing Amazon Web Services (AWS) SageMaker (e.g., a fully managed machine learning platform). This development protocol preferably includes utilization of SageMaker notebook instances for data processing, model development, and algorithmic optimization. In operation, the computer system 502 preferably leverages SageMaker's distributed training capabilities for the implementation of the NGB regressor, NGB classifier, and CoxPH survival models, as described herein. For instance, the hyperparameter optimization methodology/protocol, which evaluates numerous distinct configurations (e.g., 100 configurations), is preferably executed through Amazon's SageMaker's built-in hyperparameter tuning functionality, enabling systematic exploration of the parameter space while maintaining computational efficiency. Thus, in accordance with the illustrated embodiments, the computer system 502 may preferably implement a deployment protocol utilizing SageMaker endpoints, whereby the optimized models are deployed as scalable, production-ready inference endpoints, whereby such endpoints enable real-time prediction generation, preferably through a standardized API interface, maintaining consistent performance characteristics while accommodating variable computational demands.

With a general description being provided above with reference to FIGS. 1-4, specific description is provided below with reference to FIGS. 5-7 (and with continuing reference to FIGS. 1-4) to a system 500, and processes 600 and 700 for training, and utilizing, ML models for determining personalized costs associated with LTC.

As shown in FIG. 5, the system 500 in accordance with the illustrated embodiments preferably includes the computer system 502 coupled to one or more datasets 504, preferably consisting of one or more digital external datasets 506, and one or more digital internal datasets 508. As shown in the illustrated embodiment of FIG. 5, the external datasets 506 preferably consists of HRS 510 and MEPS 512 datasets retrieved from publicly available sources, preferably via a communication network 100. And the internal datasets 508 preferably consists of data related to LTC insurance claims data and LTC actuarial data 514, preferably both retrieved from an internal proprietary source (e.g., an insurance company). The system 500 further encompasses one or more client computing devices 550 (as further described below).

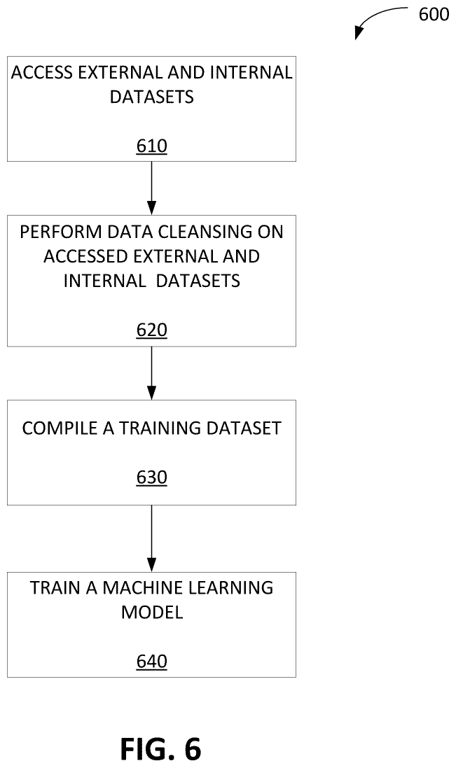

The computer system 502 preferably further includes a data cleansing module 520 communicatively coupled to each of the external 506 and internal 508 dataset for receiving data therefrom. In accordance with the illustrated embodiment of FIG. 5, the data cleansing module 520 preferably includes: a) a data transformation module 522; b) a data harmonization module 524; and c) an anomaly detection module 526, the functionality of each will be further described below with reference to process 600 of FIG. 6.

The computer system 502 further preferably includes a data training module 530 for generating a dataset (from data retrieved from each of the external 506 and internal 508 datasets) configured for training one or more ML models in an LTC ML module 540 generated, and utilized, by the computer system 502, as further described below with reference to process 600 of FIG. 6.

In accordance with the illustrated embodiment of FIG. 5, the ML module 540 is preferably configured and operative to generate probabilistic predictions across multiple health-related domains, and preferably consists of one or more of: 1) an LTC need NGB classifier 542 operative to determine the probability of one or more individuals requiring LTC during their remaining lifespan; 2) a begin age CoxPH survival model 544 operative to perform a probabilistic prediction of an age at which one or more individuals will require the commencement of LTC; and 3) an LTC prediction module 546. The LTC prediction module 546 may preferably consist of one or more of a) a duration NGB regressor 547 operative to perform probabilistic regression and predict the duration of LTC utilization for one or more individuals, and b) a cost NGB regressor 548 operative to perform probabilistic regression and predict the LTC costs during the remaining lifespan of one or more individuals. Both regressors can produce predictive distributions.

Further preferably provided in the computer system 502 is an output generator module 560 configured to provide output data representative of a request for predicted LTC costs predicated preferably upon user input data. The output generator 560 is operative and configured to interpret and present the ML model's 540 predictions and performance, preferably in a suitable format for use by a communicatively coupled client/partner computing device 550. That is, the output generator 560 preferably enhances the usability of the ML module 540 by providing clear, visual, and interpretable results to a client/partner computer device 550. As also shown in system 500 of FIG. 5, the aforesaid request for predicted LTC costs is preferably received by user data inputted via a client/partner computer device 550 (e.g., 103). Preferably, the computer system 502 further includes an input transformer module 565 for converting user data provided by the client/partner computer device 550 to a structured format suitable for processing by the LTC ML models 540 for determining personalized LTC costs in accordance with the illustrated embodiments.

With the general components of computer system 500 being shown above with reference to FIG. 5, its method of operation will now be described with reference to process 600 of FIG. 6 for training ML models 540 to perform probabilistic regression, thereby determining personalized LTC costs, expressed as predictive distributions. Starting at step 610, data is accessed by computer system 502 (preferably via communication network 100) from the one or more datasets 504, preferably consisting of one or more digital external datasets 506, and one or more digital internal datasets 508. In accordance with the illustrated embodiment of FIG. 5, the external datasets 506 may consist of publicly available a: 1) HRS dataset 510; and 2) MEPS dataset 512, and wherein the internal datasets 508 may consist of a proprietary dataset 514 associated with LTC insurance claims data and LTC actuarial data. For instance, with regard to the external datasets 506, the HRS dataset 510 may include functional limitation variables associated with one or more of: bathing; dressing; eating; walking; and incontinence management, and the MEPS dataset 512 may include functional limitation variables associated with one or more of: bending; bathing; dressing; executing errands; and finger dexterity. And with regard to the internal datasets 508 (e.g., 514), preferably included is insurance claims data associated with one or more of: claimant geographic and demographic information; claim initiation justifications; care duration metrics; and monetary claim quantities.

Next, at step 620, the computer system 502 preferably performs data cleansing (which includes converting unstructured data to structured data) preferably on each of the accessed one or more external 506 and internal 508 datasets such that each accessed dataset (e.g., 510, 512, and 514) is suitable for being aggregated in a training dataset 530 for training one or more ML models 540 relating to LTC cost predictions. In accordance with the illustrated embodiments, performing data cleansing on each of the accessed one or more external 506 and internal 508 datasets (e.g., 510, 512, and 514) includes data transformation techniques consisting of modifying data from each of the accessed datasets (e.g., 510, 512 and 514) into a common format that is suitable for utilization by ML models (e.g., 540). For instance, modifying the data from each of the accessed datasets (e.g., 510, 512 and 514) may include one or more of scaling numerical values, encoding categorical data, imputing missing values with substituted values, and ensuring consistent data types such that ML models (e.g., 540) can effectively perform predictions based on information provided by the aforesaid accessed data, preferably via data cleansing module 520. Additionally, performing data cleansing on each of the accessed datasets (e.g., 510, 512 and 514) may include data harmonization techniques for processing the accessed datasets (e.g., 510, 512 and 514) into a standardized format, wherein the harmonization techniques may consist of one or more of: a) data cleansing including removing outliers and duplicates and imputing missing values with substituted values; b) data mapping including identifying corresponding fields across different datasets and mapping them to a common schema; data standardization including converting data to a consistent format; and c) data normalization including scaling data to a common range to minimize bias, preferably via data harmonization module 524. And further in accordance with the illustrated embodiments, accessed HRS 510 and MEPS 512 datasets are preferably processed by the computer system 502 to determine harmonization, including standardization and normalization, of geographic data, demographic data, health conditions data, and lifestyle factor data, preferably via data harmonization module 524.

Additionally, the computer system 502, preferably in the data cleansing step (step 620), may be further configured and operative, responsive to data accessed for the external 506 and internal 508 datasets, to determine: a) time-to-event data constructed through identification of first recorded instances of one or more of nursing home care utilization, homecare service implementation, or presence of two or more ADL limitations; b) harmonization, including standardization and normalization, of geographic data, demographic data, health conditions data, and lifestyle factor data; and c) right-censoring for data associated with subjects not having recorded LTC service utilization within a prescribed observation period.

The computer system 502 is further additionally configured and operative to perform anomaly detection techniques for processing the accessed external 506 and internal 508 datasets into a standardized format and wherein the anomaly detection techniques preferably consist of processing the accessed external 506 and internal 508 datasets for identifying and removing unusual data points (e.g., outliers) from a training dataset 530 before using it to train ML models (e.g., 540), preferably via anomaly detection module 526. It is to be understood the anomaly detection techniques may preferably consist of utilizing Cook's distance methodology with ordinary least squares regression, whereby the computing system 502: a) calculates a statistical measure for each data point in the dataset 504; and b) eliminates observations that exceed data-driven threshold derived from the statistical measure before using it to train ML models (e.g., 540).

Next, at step 630, the computer system 502 is operative and configured to compile a training dataset 530 by aggregating each of the accessed external 506 and internal 508 datasets (e.g., 510, 512 and 514), wherein the training dataset 530 is operative to train one or more ML models 540 associated with predicting costs relating to LTC in accordance with the illustrated embodiments. Preferably, compiling a training dataset 530 includes performing data labelling techniques on data aggregated from the accessed external 506 and internal 508 datasets (e.g., 510, 512 and 514) such that the one or more ML models 540 perform supervised learning techniques predicated upon the training dataset 530.

Once the training dataset 530 is compiled (step 630), at step 640 the computer system 502 trains LTC cost ML models 540 preferably including one or more ML models (e.g., 542, 544, and 546) each being configured and operative to utilize one or more AI techniques for predicting LTC costs predicted upon certain input data related to a request for such predictions. In accordance with the exemplary illustrated embodiment of FIG. 5, the ML models 540, as mentioned above, preferably consists of one or more of: 1) an LTC need NGB classifier 542 operative to determine the probability of one or more individuals requiring LTC during their remaining lifespan; 2) a begin age CoxPH survival model 544 operative to perform a probabilistic prediction of an age at which one or more individuals will require the commencement of LTC; and 3) an LTC prediction ML module 546. The LTC prediction module 546 may preferably consist of one or more of a) a duration NGB regressor 547 operative to predict the duration of LTC utilization for one or more individuals, and b) a cost NGB regressor 548 operative to predict the LTC costs during the remaining lifespan of one or more individuals.

Preferably, each of the one or more ML model modules (e.g., 542, 544 and 546) in the trained ML models 540 is optimized through a randomized hyperparameter search protocol, including utilizing performance metrics, including mean squared error and adjusted R-squared for regression, balanced accuracy for classification, and a concordance index for survival modeling for optimizing predictive capabilities. Additionally, and in accordance with certain illustrated embodiments, the trained LTC cost ML models 540 are preferably configured to synthesize multiple indicators to determine onset of LTC needs, wherein the indicators may consist of one or more of: residency status in nursing homes or institutional care facilities; utilization of home care services; and presence of functional limitations.

Further, and in accordance with certain illustrated embodiments, the computer system 502 preferably evaluates the accuracy of the trained ML models 540 for predicting costs associated with LTC, wherein the accuracy evaluation may consists of one or more of: 1) utilizing balanced accuracy for optimizing performance of a binary classification model; 2) utilizing mean squared error and adjusted R-squared for optimizing performance of a regression model; and 3) utilizing concordance index for optimizing performance of a survival model. And in certain embodiments, computer system 502 is further caused to perform NLP techniques to transform at least a portion of text data in the training dataset 530 to a data format compatible for training ML models 540. Further, in certain embodiments, the computer system 502 is further operative and configured such that the trained ML models 540 are updated in real-time with data from one or more of the datasets 504 (e.g., 506 and 508).

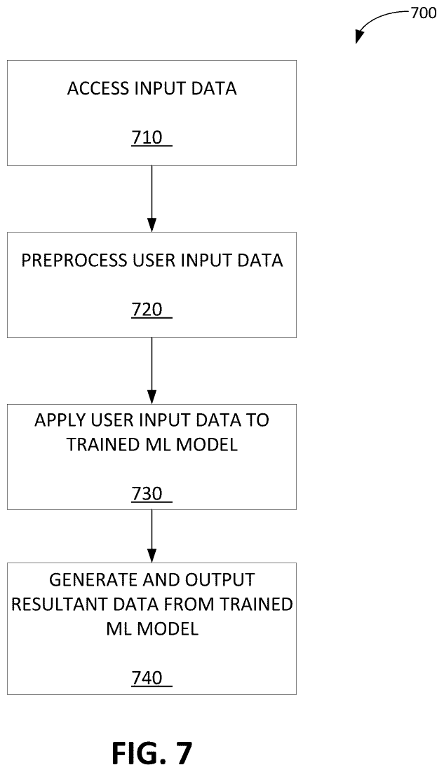

With the process 600 and system 500 for training an ML model for determining LTC cost being described above with reference to FIGS. 5 and 6, description is now provided for a process 700, with reference to FIG. 7, for utilizing trained ML models (e.g., 540), by a computer system (e.g., 502), for determining LTC costs based upon a user input request.

Starting at step 710, user data is preferably provided in a client/partner computing device 550 (e.g., 103 FIG. 1) relating to a user request for predicted LTC costs, which data is then provided to the computer system 502 communicatively coupled to the user client/partner device 550, preferably via an input transformer 565. As mentioned above, the input transformer 565 provided in the computer system 502 preferably preprocesses the user input data into a format that can be utilized by the trained ML learning models 540, step 720.

Next, at step 730, the preprocessed user input data (step 720) is applied to the trained LTC cost ML models 540 including one or more ML model modules (e.g., 542, 544, 547 and 548) each being configured and operative to utilize one or more AI techniques for predicting LTC costs, expressed as predictive distribution, predicated upon the preprocessed user input data (step 710). At step 740, the trained ML models 540 processes the applied user input data (step 730), using one or more of the aforementioned AI techniques, to generate, and output, data from the trained LTC cost ML models 540 containing predicted personalized LTC costs responsive to the user input data (step 710). For instance, and as shown in FIG. 5 (and as described above), the computer system 502 preferably includes an output generator 560 operative to provide output data representative of a request for predicted LTC costs predicated upon the user input data (step 710) by the trained ML models 540 which are preferably converted to an interpretable format for use by a client/partner computer device 550.

It is to be appreciated and understood the illustrated embodiments for determining personalized LTC costs by training, and utilizing, an ML model provides a technical improvement to prior computer systems and processes for determining personalized LTC costs, which typically were dependent upon single-source data (e.g., an actuarial produced dataset). Thus, it is to be further appreciated that the illustrated embodiments provide a transformative computer-implemented process for LTC cost prediction. For instance, by leveraging advanced data processing and ML techniques as described above, the above-described computer system (e.g., 502) and processes (e.g., 600 and 700) provides unprecedented insights into potential LTC trajectories which were not formerly capable of being performed by any prior art techniques.

Thus, the above-described illustrated embodiments provide a technical improvement to computer prediction system and processes by, for instance, enabling multiple practical applications across various domains within the LTC and financial services sectors. For example, in one implementation, insurance providers utilize the system's predictive capabilities for enhanced underwriting processes, whereby personalized risk assessments are generated through integration of multiple health indicators and demographic factors. The computer system (e.g., 502) enables actuaries to generate more precise premium calculations through comprehensive analysis of potential health trajectories and associated LTC costs. In another implementation, financial advisors leverage the system's (e.g., 502) predictive insights for retirement financial planning purposes, whereby the system generates personalized projections of potential LTC expenses. Such projections enable more accurate estimation of retirement savings requirements, accounting for various health scenarios and care needs that may arise during retirement years. It is to be appreciated and understood, in one exemplary implementation, LTC providers may implement the system (e.g., 500) for resource allocation planning, whereby predictions of care needs and duration enable more efficient staffing and facility management. It is to be further appreciated the system's (e.g., 500) ability to predict LTC onset timing and duration, through the above-described ML and AI techniques, provides valuable insights for capacity planning and service delivery optimization.

In accordance with yet another implementation of the above-described illustrated embodiments, government agencies and policy makers may utilize the system's (e.g., 500) analytical capabilities for population health management and LTC policy development. In this regard, the system (e.g., 500) enables sophisticated modeling of LTC cost trends and LTC needs across different demographic segments, facilitating evidence-based policy decisions and resource allocation strategies.

In accordance with still another implementation of the above-described illustrated embodiments, individual consumers and their financial advisors may implement the system (e.g., 500) for personalized financial planning, whereby the predictive insights enable more informed decisions regarding one or more of: a) retirement savings strategies; b) LTC insurance procurement; c) LTC coverage selection; and d) estate planning considerations.

Thus, the computer system (e.g., 500) in accordance with the illustrated embodiments described herein provide practical value across multiple stakeholder categories within the LTC and financial services ecosystem, enabling enhanced decision-making capabilities through sophisticated predictive analytics.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of the illustrated embodiments, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computing system for training a machine learning model for determining personalized costs associated with long-term care, expressed as predictive distribution, comprising:
one or more processors; and
one or more computer-readable media having stored thereon computer-executable instructions that are structured such that, when executed by the one or more processors, cause the computing system at least to:
access one or more external datasets including data related to long-term care;
access one or more internal datasets including proprietary data related to long-term care;
perform data cleansing on each of the accessed one or more external and internal datasets such that each accessed dataset is suitable for being aggregated in a training dataset for training one or more machine learning models relating to long-term care predictions;
compile a training dataset by aggregating each of the accessed datasets, wherein the training dataset is operative to train one or more machine learning models associated with predicting costs relating to long-term care; and
train a long-term care cost model including one or more machine learning models each being configured and operative to utilize one or more artificial intelligence techniques for predicting personalized long-term care costs predicted upon certain input data related to a request for such predictions.

2. The computing system for training a machine learning model as recited in claim 1, wherein the trained machine learning model further includes an output generator module configured to provide output data representative of the request for predicted long-term care costs predicated upon certain input data.

3. The computing system for training a machine learning model as recited in claim 1, wherein the external datasets consist of publicly available: 1) a Health and Retirement Study dataset; and 2) a Medical Expenditure Panel Survey dataset, and wherein the internal datasets consist of: 1) a proprietary dataset associated with long-term care insurance claims data; and 2) a proprietary dataset associated with long-term care actuarial data.

4. The computing system for training a machine learning model as recited in claim 3, wherein the Health and Retirement Study and Medical Expenditure Panel Survey datasets are processed by the one or more processors to determine: a) time-to-event data constructed through identification of first recorded instances of one or more of nursing home utilization, home care service implementation, or presence of two or more activities of daily living limitations; b) harmonization, including standardization and normalization, of geographic data, demographic data, health conditions data, and lifestyle factor data; and c) right-censoring for data associated with subjects not having recorded long-term care service utilization within an observation period.

5. The computing system for training a machine learning model as recited in claim 3, wherein the Health and Retirement Study dataset includes functional limitation variables associated with one or more of: bathing; dressing; eating; walking; and incontinence management, and the Medical Expenditure Panel Survey dataset includes functional limitation variables associated with one or more of: bending; bathing; dressing; executing errands; and finger dexterity.

6. The computing system for training a machine learning model as recited in claim 3, wherein the internal datasets include insurance claims data associated with one or more of: claimant geographic and demographic information; claim initiation justifications; long-term care duration metrics; and monetary claim quantities.

7. The computing system for training a machine learning model as recited in claim 3, wherein performing data cleansing on each of the accessed one or more external and internal datasets include data transformation techniques consisting of modifying data from each of the accessed external and internal datasets into a common format that is suitable for utilization by a machine learning model.

8. The computing system for training a machine learning model as recited in claim 7, wherein modifying the data from each of the accessed external and internal datasets includes one or more of: scaling numerical values; encoding categorical data; imputing missing values with substituted values; and providing consistent data types such that the trained machine learning model effectively performs predictions based on information provided by the accessed one or more external and internal datasets.

9. The computing system for training a machine learning model as recited in claim 7, wherein performing data cleansing on each of the accessed one or more external and internal datasets includes data harmonization techniques for processing the accessed external and internal datasets into a standardized format.

10. The computing system for training a machine learning model as recited in claim 9, wherein the harmonization techniques consist of one or more of: data cleansing, including removing outliers and duplicates and imputing missing values with substituted values; data mapping, including identifying corresponding fields across different datasets and mapping them to a common schema; data standardization, including converting data to a consistent format; and data normalization, including scaling data to a common range to minimize bias.

11. The computing system for training a machine learning model as recited in claim 10, wherein performing data cleansing on each of the accessed one or more external and internal datasets include anomaly detection techniques for processing the accessed external and internal datasets into a standardized format, wherein the anomaly detection techniques consist of processing the accessed external and internal datasets for identifying and removing outlier data points from a dataset before using it to train a machine learning model.

12. The computing system for training a machine learning model as recited in claim 11, wherein the anomaly detection techniques further consist of utilizing Cook's distance algorithm with ordinary least squares regression, whereby the computing system: calculates a statistical measure for each data point in the accessed datasets; and eliminates observations that exceed data-driven threshold derived from the statistical measure before using it to train a machine learning model.

13. The computing system for training a machine learning model as recited in claim 12, wherein compiling a training dataset includes performing data labelling techniques on data aggregated from the accessed external and internal datasets such that a machine learning model performs supervised learning predicated upon the training dataset.

14. The computing system for training a machine learning model as recited in claim 13, wherein the trained long-term care cost model consists of one or more of: 1) a first natural gradient boosting regressor configured for determining long-term care durations expressed as predictive distribution; 2) an natural gradient boosting classifier configured for determining long-term care need assessment; 3) a second natural gradient boosting regressor configured for determining long-term care expenses expressed as predictive distribution; and 4) a Cox Proportional Hazards survival model configured for determining long-term care begin age for one or more individuals.

15. The computing system for training a machine learning model as recited in claim 14, wherein the one or more machine learning model modules comprise a long-term care cost prediction module consisting of a duration natural gradient boosting regressor operative to predict the duration of long-term care utilization for one or more individuals and a cost natural gradient boosting regressor operative to predict the long-term care costs during the remaining lifespan of one or more individuals.

16. The computing system for training a machine learning model as recited in claim 1, wherein the trained long-term care cost model is configured to synthesize multiple indicators to determine onset of long-term care needs, wherein the indicators consist of one or more of: residency status in nursing homes or institutional care facilities; utilization of home health care services; and presence of functional limitations.

17. The computing system for training a machine learning model as recited in claim 14, wherein each of the one or more machine learning models is optimized through a randomized hyperparameter search protocol, including utilizing performance metrics, including mean squared error and adjusted R-squared for regression, balanced accuracy for classification, and concordance index for survival modeling for optimizing predictive capabilities.

18. The computer system for training a machine learning model as recited in claim 1, wherein the computer system is further caused to convert unstructured data to structured data suitable for training the machine learning model.

19. The computer system for training a machine learning model as recited in claim 1, wherein the computer system is further caused to perform natural language processing techniques to transform at least a portion of text data in the accessed dataset to a data format compatible for training the machine learning model.

20. The computer system for training a machine learning model as recited in claim 19, wherein the computer system is further caused to evaluate the accuracy of the trained machine learning model for predicting costs associated with long-term care, wherein the evaluation consists of: 1) utilizing balanced accuracy for optimizing performance of a binary classification model; 2) utilizing mean squared error and adjusted R-squared for optimizing performance of a regression model; and 3) utilizing concordance index for optimizing performance of a survival model.

21. A computer-implemented process for training a machine learning model for determining personalized costs associated with long-term care, expressed as predictive distribution, comprising the steps:
accessing one or more external datasets including data related to long-term care;
accessing one or more internal datasets including proprietary data related to long-term care;
performing data cleansing on each of the accessed one or more external and internal datasets such that each accessed dataset is suitable for being aggregated in a training dataset for training one or more machine learning models relating to long-term care predictions;
compiling a training dataset by aggregating each of the accessed datasets, wherein the training dataset is operative to train one or more machine learning models associated with predicting costs relating to long-term care; and
training a long-term care cost model including one or more machine learning model modules each being configured and operative to utilize one or more artificial intelligence techniques for predicting personalized long-term care costs predicted upon certain input data related to a request for such predictions.

22. A computer-implemented method that utilizes a trained machine learning model for determining personalized costs associated with long-term care, expressed as predictive distribution, comprising the steps:
accessing input data relating to a user request for predicted personalized costs associated with long-term care;
preprocessing the user input data into a format that can be utilized by the trained machine learning model;
applying the preprocessed user input data to the trained long-term care model including one or more machine learning model modules each being configured and operative to utilize one or more artificial intelligence techniques for predicting personalized long-term care costs predicated upon the preprocessed user input data; and
generating and output data from the trained long-term care cost model containing predicted personalized long-term care costs responsive to the user input data.
